(19) United States
(12) Patent Application Publication
(10) Pub. No.: US 2009/0214831 A1
(43) Pub. Date: Aug. 27, 2009

(54) Polymeric carriers for vehicle seals

(76) Inventors: Hans-Joachim Graf, Bad Soden-Salmuenster (DE); John Seed, Stratford (CA); Thomas Gonder, London (CA); Siva Gnananathan, Stratford (CA); John Seward, Stratford (CA); Zuoxing Yu, Stratford (CA)

Correspondence Address: Fay Sharpe LLP, 1228 Euclid Avenue, 5th Floor, The Halle Building, Cleveland, OH, 44115, US

(21) Appl. No.: 11/587,610

(22) PCT Filed: Apr. 28, 2005
(86) PCT No.: PCT/US05/14804

§ 371 Date: Jun. 16, 2008

Related U.S. Application Data
(60) Provisional application No. 60/565,877, filed on Apr. 28, 2004.

(51) Int. Cl. B32B 3/00; B32B 9/04; B32B 27/36; B32B 27/34; B32B 27/32; B32B 27/08; B32B 27/06; B32B 27/00; B32B 27/38; B32B 3/02; B32B 3/04; B32B 3/28; B32B 3/30; E06B 7/16; B60J 1/02; B60J 1/20; B60J 10/02

(52) U.S. Cl. 428/182; 428/411.1; 428/412; 428/474.4; 428/523; 428/521; 428/480; 428/473.5; 428/413; 428/98; 428/179; 428/426; 264/171.13

(57) ABSTRACT

Disclosed is a carrier component for use in a vehicle sealing assembly such as a weatherstrip assembly. The carrier is formed from a non-metallic material, and preferably from a polymeric material. Also disclosed are vehicular sealing assemblies utilizing such carriers, and related methods of forming such sealing assemblies.

### FIELD OF THE INVENTION

The present invention relates to the field of vehicle seals such as automotive weather seals, and specifically, to carriers used in forming such seals.

### BACKGROUND OF THE INVENTION

Sealing assemblies are utilized in vehicle door assemblies to prevent the ingress of water and other environmental factors into the passenger compartment. Typically, such sealing assemblies utilize a relatively stiff supporting carrier member about which is formed a flexible body. The carrier is metal and the sealing body is typically formed from an elastomeric material. Generally, the elastomer is molded or extruded about the carrier. The body may include one or more sealing members that project outward and are designed to provide or assist in, the sealing function of the assembly. The assembly is generally mounted along the interface between a door and a vehicle body or panel.

Metallic carriers provide numerous benefits to the resulting sealing assembly. However, the use of a metal for the carrier has several disadvantages such as, but not limited to, susceptibility to corrosion, increases in manufacturing complexity and particularly in providing protection against such corrosion, increased weight of the assembly using such a carrier, and overall increases in the cost of such materials and increased manufacturing operations.

Accordingly, there is a need for a carrier that can be used in a vehicle sealing assembly that avoids the aforementioned problems. Further, there is a need for a sealing assembly utilizing such a carrier.

### SUMMARY OF THE INVENTION

In a first aspect, the present invention provides a sealing assembly adapted for installation on a vehicle. The sealing assembly comprises a non-metallic carrier and an elastomeric body disposed about the carrier. The body defines an outer region for sealing when the assembly is installed on a vehicle.

In another aspect, the present invention provides a sealing assembly comprising a carrier formed from a material including a polymer and a filler component. The sealing assembly also comprises an elastomeric body disposed on the carrier.

In yet another aspect, the present invention provides a process for forming a seal assembly adapted for use in a vehicle. The process comprises providing a polymeric material. The process also comprises a step of extruding the polymeric material into a desired configuration to form a carrier. The process also comprises a step of providing an elastomeric material suitable for use in the seal assembly. And, the process includes a step of depositing the elastomeric material on the carrier to thereby form the seal assembly.

### BRIEF DESCRIPTION OF THE DRAWINGS

FIG. 1 is a perspective view of a preferred embodiment carrier according to the present invention.

FIG. 2 is a perspective view of another preferred embodiment carrier according to the present invention.

FIG. 3 is perspective view of yet another preferred embodiment carrier according to the present invention.

FIG. 4 is an end view of another preferred embodiment carrier according to the present invention.

FIG. 5 is an end view of another preferred embodiment carrier according to the present invention.

FIG. 6 is an end view of another preferred embodiment carrier according to the present invention.

FIG. 7 is an end view of another preferred embodiment carrier according to the present invention.

### DETAILED DESCRIPTION OF THE PREFERRED EMBODIMENTS

The present invention relates to a non-metallic and preferably polymeric carrier used in a seal or seal assembly for a vehicle. The use of a polymeric carrier reduces the weight of the resulting seal assembly, eliminates undesirable process steps concerning detail moldings, and eliminates corrosion protection operations otherwise required if a metallic carrier is used in the vehicle seal assembly.

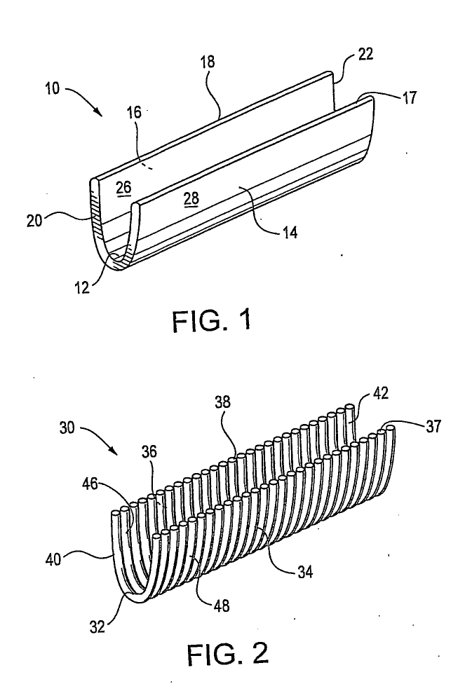

FIG. 1 illustrates a first preferred embodiment carrier 10 according to the present invention. The preferred embodiment carrier 10 includes a first sidewall 14, a second sidewall 16, and a base 12 generally extending and adjoined to the first and second sidewalls 14 and 16. The resulting U-shaped cross-section body defines a first end 20, a second opposite end 22, and a pair of edges or lips 17,18. Preferably, the edges 17, 18 project upward from the base 12 and each defines a distal edge of a respective sidewall, 14, 16. It will be seen from FIG. 1 that preferably, the edges 17 and 18 extend parallel to one another, and preferably parallel with the longitudinal axis of the carrier 10. And, it is preferred that the sidewalls 14 and 16 are parallel to one another, or at least substantially so. The carrier 10 defines an outer surface 28. And, the carrier 10 defines an opposite, inner surface 26.

FIG. 2 illustrates a second preferred embodiment carrier 30 according to the present invention. The carrier 30 includes a first sidewall 34, a second sidewall 36, and a base 32 generally extending between and adjoined to the first and second sidewalls 34 and 36. It will be noted that each of the sidewalls 34 and 36, and preferably, also the base 32, are formed from a plurality of tubular-shaped bodies or segmented regions that are disposed alongside one another in a parallel fashion and preferably adjoined to adjacent members on each side. Preferably, each body or segmented region extends in a perpendicular direction to the longitudinal axis of the carrier 30. This configuration or rather, collection of segmented regions, is referred to herein as a “corrugated configuration.” The carrier 30 defines a first end 40, a second opposite end 42, and a pair of upper edges or lips 37 and 38. The carrier 30 also includes an outer surface 48 and an inner surface 46.

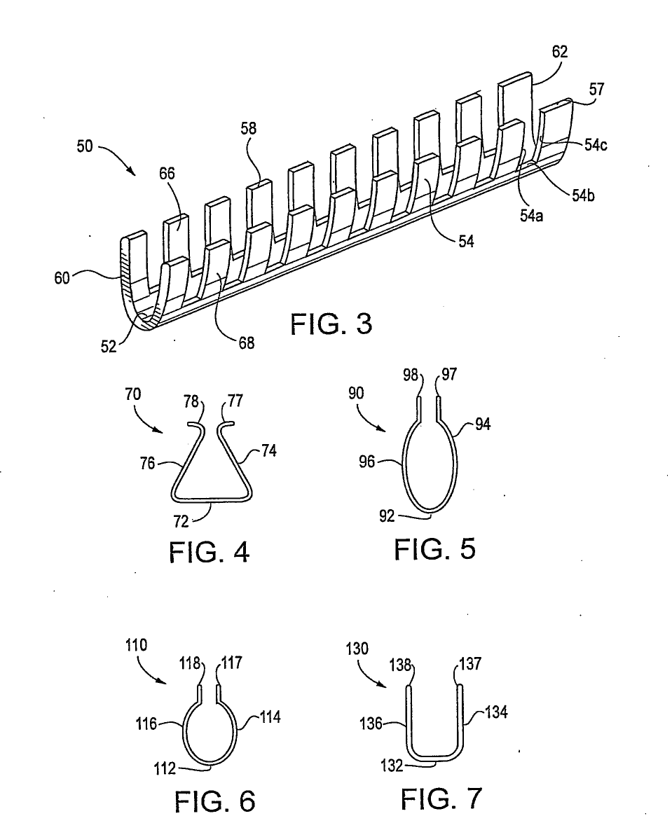

FIG. 3 illustrates another preferred embodiment carrier 50 according to the present invention. In this version, the carrier 50 includes first and second sidewalls 54 and 58, and a base 52 extending between the first and second sidewalls 54 and 58. Preferably defined in each of the sidewalls 54 and 58, are a plurality of voids or openings. For example, one of the plurality of openings defined in the sidewall 54, is defined by two generally parallel edges 54A and 54C extending from an upper edge 57 toward the base 52 to a bottom edge 54B. Preferably, the edges 54A and 54C are oriented at right angles to the bottom edge 54B. It will be appreciated that the other sidewall 58 includes a similar plurality of apertures or openings defined therein. The configuration of the carrier depicted in FIG. 3 is referred to herein as a “notched configuration.” The carrier 50 further defines a first end 60, and a second, generally opposite end 62. The carrier 60 also defines an outer surface 68 and an inner surface 66.

FIGS. 4 to 7 illustrate other preferred configurations for other preferred carriers in accordance with the present invention. Specifically, FIG. 4 illustrates a carrier 70 having a generally triangular-shaped cross section. Carrier 70 includes first and second sidewalls 74 and 76, generally extending between a base portion 72. Defined along the distal ends of these first and second sidewalls 74 and 76 are end regions 77 and 78. Although the end regions 77 and 78 are depicted in FIG. 4 as arcuate in end view, the present invention includes embodiments in which the end regions are directed outward or otherwise, and without such curved portions.

FIG. 5 illustrates another preferred embodiment carrier 90 in accordance with the present invention. Carrier 90 generally has an oval-shaped cross section. Carrier 90 includes first and second sidewalls 94 and 96 that extend from a base region 92. The distal ends of the first and second sidewalls 94 and 96 define first and second edges 97 and 98.

FIG. 6 illustrates yet another preferred embodiment carrier 110 in accordance with the present invention. Carrier 110 generally has a circular-shaped cross section. The carrier 110 includes first and second sidewalls 114 and 116 which extend between and are adjoined to a base region 112. The first sidewall defines a first edge 117, and the second sidewall 116 defines a second edge 118.

FIG. 7 illustrates yet another preferred embodiment carrier 130 in accordance with the present invention. Carrier 130 generally resembles the cross section of carrier 10, however, the carrier 130 is generally more square-like as described in greater detail herein. The carrier 130 includes first and second sidewalls 134 and 136 that generally extend upward from a base 132. Preferably, each of the sidewalls 134 and 136 is oriented at right angles with respect to the base 132. Also, it is preferred that each of the sidewalls 134 and 136 generally extend in a parallel fashion with each other as they project upward from the base 132. In certain embodiments, the width of the base 132 may be greater than, or in other embodiments, lesser than, the height of the sidewalls 134, 136. Defined along a distal end of the first sidewall 134 is an edge 137. And, defined along a distal end of the second sidewall 136, is another edge 138.

It will be appreciated that the non-metallic carriers according to the present invention may be formed to exhibit a variety of cross-sectional shapes. In addition to those previously described and shown in the referenced figures, the present invention includes carriers having cross sections that are V-shaped, polygonal-shaped, arcuate-shaped, and other complex shapes. Furthermore, although all the carriers illustrated in the referenced figures have an open cross section, the present invention includes embodiments in which the carrier cross section is closed. That is, the carrier has a cross section that is only accessible from its ends, for example a hollow tube. Moreover, the present invention encompasses carriers having other shapes and forms including closed configurations as previously described, however defining one or more openings or apertures in the sidewall permitting access to the interior of the carrier. Such configurations may be beneficial in reducing the weight and amount of material used in forming the carrier, and may further contribute to the rigidity and physical characteristics of the carrier.

The thickness of the carrier, such as measured along a sidewall or a base, is generally the minimum thickness necessary to provide the required rigidity and strength to the resulting seal assembly when the carrier is incorporated therein. As will be appreciated by those skilled in the art, the thickness will depend, at least in part, upon the particular material(s) selected for use in forming the carrier.

As noted, in accordance with the present invention, the carrier is formed from a non-metallic material, and preferably from one or more polymeric materials. A wide array of polymeric materials may be used in forming the carrier of the present invention. Generally, the polymer that is selected must be one that is able to withstand the relatively high temperatures to which the carrier will be exposed during manufacture of the seal assembly. Generally, such temperatures are 150° C. or higher. Thus, it is necessary that the selected polymer not melt, deform, or undergo any significant shape change upon being heated to the maximum manufacturing temperature.

Examples of preferred materials for forming the polymeric carrier include, but are not limited to polyamides (nylon 6, nylon-6,6), polycarbonate (PC), polyacetal, crosslinkable high-density polyethylene (HDPE), polypropylene (PP), acrylonitrile butadiene styrene (ABS), a PC/ABS alloy, polybutyleneterephthalate (PBT), polyphenyleneether (PPE) materials, and modified polyphenyleneether (PPE mod) materials. Other preferred materials include, but are not limited to, ketone polymers, such as polyetheretherketone (PEEK), sulfone polymers, and imide polymers. Combinations of any of these materials may also be used.

Many of these preferred polymeric materials are commercially available. For instance, a particularly attractive nylon 6 resin is available from BASF under the designation ULTRAMID® (or ULTRAMID® B3) Polyamide 6. A preferred type of thermoplastic polyester based upon PBT is available from BASF under the designation ULTRADUR PBT thermoplastic polyester. A preferred type of PPE is VESTORAN available from Degussa.

Any of the mentioned materials can also be filled by or otherwise combined with talc or fibers such as mineral or organic fibers. The selected fibers may be short or long. These materials are generally referred to as filler components herein.

Examples of mineral fibers include graphite, asbestos fibers, or glass fibers. Examples of organic fibers include nylon fibers, KEVLAR fibers, or PEEK fibers. Preferred fibers include glass fibers and KEVLAR fibers. As will be appreciated by those skilled in the art, KEVLAR is available from E. I. DuPont, and is poly(p-phenyleneterephthalamide).

If a filled polymeric material is used, the concentration of the filler material is generally determined according to the particular requirements of the end use application. The present invention includes a wide range of fill concentrations, such as for example, from about 0.10% to 30%, and preferably, from about 1.0% to about 20% (all percentages expressed herein are percentages by weight, unless noted otherwise). However, it will be appreciated that the present invention includes fill concentrations greater than or lesser than these exemplary concentrations.

The preferred polymer for use in forming the carrier is a polycarbonate, nylon, or polyacetal polymer.

The present invention also includes embodiments in which the carrier is formed from a combination of materials, and in which the materials are combined in particular fashions. For example, the carrier may comprise a plurality of non-metallic or polymeric materials. Alternately, the carrier can also be formed from a combination of one or more non-metallic or polymeric materials combined with one or more metals. The various material combinations may be made by forming aggregate mixtures of the materials, forming layered arrays of the materials, or forming segregated regions of different materials or material combinations.

As noted, it is typical to form a sealing body about or upon the carrier. The body is typically formed from one or more elastomeric materials.

The elastomer selected for use in the preferred sealing assemblies described herein, can be any of a number of materials exhibiting a good combination of weatherability, flexibility, heat aging properties and dimensional stability. The elastomer must be susceptible to forming and be able to follow the contours of an outer body panel or door of a vehicle. Suitable thermoplastic elastomers include, but are not limited to, various block copolymers such as styrenic, polyester or polyurethane block copolymers; thermoplastic/elastomer blends such as thermoplastic polyolefins and thermoplastic vulcanizates, particularly copolymers of a polyolefin and (ethylene-propylene-diene terpolymer) EPDM; and ionomeric thermoplastic elastomers. Preferably, the thermoplastic elastomer used in the preferred embodiments will have a Shore A hardness of from about 55 to 75. This range provides the required stiffness necessary to provide effective support while still being soft enough to provide effective sealing. In addition, the material must be able to resist chemical attack from conventional automotive cleaning products as well as pass industry specification tests for seal and trim strips. A preferred group of thermoplastic elastomers for use in the present invention are a class of dynamically vulcanized PP/EPDM materials available under the trademark SANTOPRENE™ and commercially available from Advanced Elastomer Systems. Of course, other commercially available TPVs and TPEs may be used as well.

The elastomer used in the preferred sealing assemblies may further comprise various additives known in the art, including, but not limited to pigments, plasticizers, UV absorbers, hindered amine light stabilizers, antioxidants, adhesion promoters, foaming agents, and mixtures of these additives. The total amount of additive may be up to 50% by weight of the composition, depending on what additives are used.

Additionally, one or more outer layers may be formed on the sealing assembly. Such outer layers can be, for example, a low friction outer layer such as formed from one or more ultra-high molecular weight polyethylenes. In addition, one or more outer show layers may be provided that generally exhibit a pleasing aesthetic appearance. Such outer show layers may be colored to match the color of the vehicle door or body. Outer show layers may for instance, be formed from a polymeric material, and preferably an ionomeric polymer material.

The preferred embodiment carrier is preferably formed by obtaining a mixture or blend of the selected polymer, which may be filled by talc, mineral or organic fibers. The blend is then heated to a temperature sufficient to cause melting of the material. The melted material is then directed to an extruder through which it is forced into the desired cross-sectional shape. At this point, one or more additional layers of materials may be deposited upon or about, or co-extruded with the carrier. The resulting assembly is then allowed to cool and later incorporated in a seal assembly process, e.g. a weatherstrip manufacturing process.

In the event the newly extruded carrier is utilized in a seal assembly process, typically, the carrier will be mated or otherwise joined with a rubber or EPDM material. The rubber EPDM material is generally co-extruded about the carrier body.

The present invention includes processes in which the non-metallic carrier is separately formed and stored for subsequent incorporation in a sealing assembly.

Prior to extrusion of the material to form the polymeric carrier, it is preferred to dry the polymeric material or polymeric blend to drive off any water or moisture contained therein. A series of trials were performed to determine preferred drying times and temperatures for driving off moisture and any organic vapors from several preferred commercially available polymeric materials that can be used in forming the carriers described herein. The results of these trials are summarized below in Table 1.

TABLE 1
Drying Times and Temperatures

| | | | TIME | |
|---|---|---|---|---|
| | TEMPERATURE | | (hours) | Vapors |
| Ultramid Nylon | 80-110° C. | (175-230 F.) | 2-4 | At 310 C.- |
| Resin (PA) | | | | 590 F. |
| UltradurB 4500 | 90-121° C. | (175-250 F.) | 3-8 | At 270 C.- |
| Thermoplastic | 100 to 140° C. | (212-284 F.) | 3-6 | 520 F. |
| Polyester (PBT) | | | | |
| Ultramid B3 | 79.5° C. | (175 F.) | 2-4 | At C. |
| Natural Nylon 6 | | | | |
| Vestoran | 110-120° C. | (230-250 F.) | 1-2 | |

It was found that drying the polymeric materials prior to extrusion to form the carriers of the present invention led to improved processing and manufacturability of the resulting carriers.

Another series of trials were undertaken to determine optimal extrusion conditions utilizing various polymeric materials in forming the preferred embodiment carriers. The results of these tests are set forth below in Tables 2-5. Although depending upon the particular material selected for forming the carrier, it appears that an extrusion temperature in the range of from about 490° F. to about 540° F. is preferred for most processes.

TABLE 2
ULTRAMID ® B3 NATURAL NYLON 6

| | TRIAL 1 | TRIAL 2 | TRIAL 3 | TRIAL 4 |
|---|---|---|---|---|
| Extruder Stage 1 | 475° F. | 440° F. | 460° F. | 460° F. |
| Extruder Stage 2 | 475° F. | 440° F. | 470° F. | 470° F. |
| Extruder Stage 3 | 475° F. | 440° F. | 490° F. | 490° F. |
| ADAPTER | | | | |
| SCREEN | | | | |
| DIE | 475° F. | 390° F. | 470° F. | 490° F. |
| COMMENTS | Watery | NO | | Liquid flow |
| | | STRENGTH | | does not |
| | | | | retain die |
| | | | | shape. Air |
| | | | | bubbles |
| | | | | appeared |
| | | | | upon exiting |
| | | | | die |
| | | | | No strength to |
| | | | | ribbon. |

In the trials summarized by Table 2, the sole polymer component was ULTRAMID® B3 Natural Nylon 6. No screen pack was used in the extruder. It can be seen that if relatively high temperatures are used in the extruder, as in trial 4, the resulting extruded carrier does not retain its shape and has insufficient strength and rigidity.

TABLE 3
ULTRADUR ® 4500 PBT Polyester

| | TRIAL 1 | TRIAL 2 | TRIAL 3 | TRIAL 4 | TRIAL 5 | TRIAL 6 |
|---|---|---|---|---|---|---|
| Extruder Stage 1 | 450° F. | 370° F. | 410° F. | 450° F. | 475° F. | 460° F. |
| Extruder Stage 2 | 460° F. | 405° F. | 405° F. | 450° F. | 475° F. | 470° F. |
| Extruder Stage 3 | 480° F. | 380° F. | 410° F. | 450° F. | 475° F. | 490° F. |
| ADAPTER | | | | | | |
| SCREEN | | | | | | |
| DIE | 400° F. | 360° F. | 380° F. | 420° F. | 450° F. | 490° F. |
| COMMENTS | Watery | STOPPED | Partially | Melted | Melted | Clear material |
| | | EXTRUDER | unmelted | | | when extruding. |
| | | The screw | material | | | Would not retain |
| | | stopped turning | | | | die shape. |
| | | due to material. | | | | |
| | | was below melt | | | | |
| | | temperature. | | | | |

In the trial summarized in Table 3, the sole polymer component was ULTRADUR® B4500 PBT Polyester. No screen pack was used. It can be seen from the comments for each trial, that the temperatures used in trials 4 and 5 are preferred.

TABLE 4
VESTORAN ® 1900 Natural

| | TRIAL |
|---|---|
| Extruder Stage 1 | 490° F. |
| Extruder Stage 2 | 490° F. |
| Extruder Stage 3 | 490° F. |
| ADAPTER | |
| SCREEN | |
| DIE | 460° F. |

Generally, the temperatures used in the single trial summarized in Table 4 for VESTORAN® 1900 Natural were acceptable. The polymer component was entirely the noted grade of VESTORAN®.

TABLE 5
POLYCARBONATE

| | TRIAL 1 | TRIAL 2 | TRIAL 3 | TRIAL 4 |
|---|---|---|---|---|
| Extruder Stage 1 | 520° F. | 560° F. | 540° F. | 570° F. |
| Extruder Stage 2 | 510° F. | 540° F. | 540° F. | 580 F |
| Extruder Stage 3 | 500° F. | 520° F. | 540° F. | 580° F. |
| ADAPTER | | | | |
| SCREEN | | | | |
| DIE | 490° F. | 500° F. | 500° F. | 520° F. |

In the trials summarized in Table 5, the polymer component was entirely polycarbonate. The relatively high temperatures necessitated a rather fast process in producing the carrier and resulting seal assembly. However, the temperatures employed in all trials were acceptable.

The foregoing discussion discloses and describes various exemplary embodiments of the present invention. One skilled in the art will readily recognize from such discussion, and from the accompanying drawings and claims, that various changes, modifications and variations can be made therein without departing from the spirit and scope of the invention as defined in the following claims.

1. A sealing assembly adapted for installation on a vehicle, said sealing assembly comprising:
a non-metallic carrier; and
an elastomeric body disposed about said carrier, said body defining an outer region for sealing when said assembly is installed on a vehicle.

2. The sealing assembly of claim 1 wherein said non-metallic carrier comprises a polymeric material.

3. The sealing assembly of claim 2 wherein said polymeric material is selected from the group consisting of polyamide, polycarbonate, high-density polyethylene, polypropylene, acrylonitrile butadiene styrene, polybutyleneterephthalate, polyphenyleneether, polyketone, polysulfone, polyimide, and combinations thereof.

4. The sealing assembly of claim 2 wherein said non-metallic carrier further comprises at least one of talc and fibers.

5. The sealing assembly of claim 4 wherein said fibers are selected from the group consisting of graphite fibers, asbestos fibers, glass fibers, nylon fibers, poly(p-phenyleneterephthalamide) fibers, polyetheretherketone fibers, and combinations thereof.

6. The sealing assembly of claim 2 wherein said polymeric material is a nylon.

7. The sealing assembly of claim 2 wherein said polymeric material is a polybutyleneterephthalate thermoplastic polyester.

8. The sealing assembly of claim 2 wherein said polymeric material is a polycarbonate.

9. The sealing assembly of claim 2 wherein said polymeric material is a polyacetal.

10. The sealing assembly of claim 1 wherein said non-metallic carrier has a cross-sectional configuration selected from the group consisting of a U-shaped, triangular-shaped, oval-shaped, circular-shaped, V-shaped, polygonal-shaped, and arcuate-shaped.

11. The sealing assembly of claim 1 wherein said non-metallic carrier has a corrugated configuration.

12. The sealing assembly of claim 1 wherein said non-metallic carrier has a notched configuration.

13. The sealing assembly of claim 1 further comprising:
an outer layer disposed on said body, said outer layer formed from a material different from the material forming said body.

14. A sealing assembly comprising:
a carrier formed from a material including a polymer and a filler component; and
an elastomeric body disposed on said carrier.

15. The sealing assembly of claim 14 wherein said polymeric material is selected from the group consisting of polyamide, polycarbonate, high-density polyethylene, polypropylene, acrylonitrile butadiene styrene, polybutyleneterephthalate, polyphenyleneether, polyketone, polysulfone, polyimide, and combinations thereof.

16. The sealing assembly of claim 14 wherein said filler component is selected from the group consisting of talc, fibers, and combinations thereof.

17. The sealing assembly of claim 16 wherein said fibers are selected from the group consisting of graphite fibers, asbestos fibers, glass fibers, nylon fibers, poly(p-phenyleneterephthalamide) fibers, polyetheretherketone fibers, and combinations thereof.

18. The sealing assembly of claim 14 wherein said filler component constitutes from about 0.10% to about 30% of the weight of said carrier.

19. A process for forming a seal assembly adapted for use in a vehicle, said process comprising:
providing a polymeric material;
extruding said polymeric material into a desired configuration to form a carrier;
providing an elastomeric material suitable for use in said seal assembly; and
depositing said elastomeric material on said carrier to thereby form said seal assembly.

20. The process of claim 19 wherein said step of providing said polymeric material is performed by selecting said polymeric material from the group consisting of polyamide, polycarbonate, high-density polyethylene, polypropylene, acrylonitrile butadiene styrene, polybutyleneterephthalate, polyphenyleneether, polyketone, polysulfone, polyimide, and combinations thereof.
